(19) United States
(12) Patent Application Publication
(10) Pub. No.: US 2021/0159736 A1
(43) Pub. Date: May 27, 2021

(54) TRANSMISSION MODULE AND WIRELESS POWER DATA TRANSMISSION DEVICE

(71) Applicant: Panasonic Intellectual Property Management Co., Ltd., Osaka (JP)

(72) Inventors: Hideaki MIYAMOTO, Osaka (JP); Tsutomu SAKATA, Osaka (JP); Masato MATSUMOTO, Osaka (JP)

(21) Appl. No.: 17/041,891

(22) PCT Filed: Mar. 26, 2019
(86) PCT No.: PCT/JP2019/012795

§ 371 Date: Sep. 25, 2020

(30) Foreign Application Priority Data
Mar. 29, 2018 (JP) 2018-064039

(51) Int. Cl. H02J 50/70; H02J 50/80; H02J 50/12

(52) U.S. Cl. CPC H02J 50/70; H02J 50/12; H02J 50/80

(57) ABSTRACT

An object is to improve the communication quality in a system for wirelessly transmitting electric power and data. A transmission module is used as a power transmitting module or a power receiving module in a wireless power data transmission device for wirelessly transferring electric power and data between the power transmitting module and the power receiving module. The transmission module includes: a coil for transmitting or receiving electric power through magnetic field coupling; a communication electrode for transmitting or receiving signals through electric field coupling; a first conductive shield that is located between the coil and the communication electrode; and a second conductive shield that is located between the coil and the first conductive shield.

### TECHNICAL FIELD

The present disclosure relates to a transmission module and a wireless power data transmission device.

### BACKGROUND ART

Systems have been known in the art for transmitting electric power and data wirelessly, i.e., in a contactless manner. For example, Patent Document No. 1 discloses a device that wirelessly transfers energy and data between two objects that rotate relative to each other on a rotation axis. The device includes two circular or arc-shaped coils for transferring energy, and two circular or arc-shaped conductors for transferring data. The two coils oppose each other while being spaced apart from each other in the axial direction of the rotation axis, and transfer energy through inductive coupling. The two conductors are arranged in a coaxial relationship with the two coils, respectively. The conductors oppose each other while being spaced apart from each other in the axial direction, and transfer data through electrical coupling. A shielding object made of a conductive material is arranged between the two coils and the two conductors.

### CITATION LIST

### Patent Literature

Patent Document No. 1: Japanese Laid-Open Patent Publication No. 2016-174149

### SUMMARY OF INVENTION

### Technical Problem

The present disclosure provides a technique for improving communication quality of a system for wirelessly transferring electric power and data between two objects.

### Solution to Problem

A transmission module according to one aspect of the present disclosure is used as a power transmitting module or a power receiving module in a wireless power data transmission device for wirelessly transferring electric power and data between the power transmitting module and the power receiving module. The transmission module includes: a coil for transmitting or receiving electric power through magnetic field coupling; a communication electrode for transmitting or receiving signals through electric field coupling; a first conductive shield that is located between the coil and the communication electrode; and a second conductive shield that is located between the coil and the first conductive shield.

The general and specific aspects of the present disclosure may be implemented using a device, a system, a method, an integrated circuit, a computer program or a storage medium, or any combination of devices, systems, methods, integrated circuits, computer programs and storage media.

### Advantageous Effects of Invention

According to an embodiment of the present disclosure, it is possible to improve the communication quality in a system for wirelessly transferring electric power and data between a power transmitting module and a power receiving module.

### BRIEF DESCRIPTION OF DRAWINGS

FIG. 1 is a diagram schematically showing an example of a robot arm device having a plurality of moving parts.

FIG. 2 is a diagram schematically showing a wiring configuration of a conventional robot arm device.

FIG. 3 is a diagram showing a specific example of the conventional configuration shown in FIG. 2.

FIG. 4 is a diagram showing an example of a robot that wirelessly transfers electric power at each joint.

FIG. 5 is a diagram showing an example of a robot arm device to which wireless power transmission is applied.

FIG. 6 is a cross-sectional view showing an example of a power transmitting module and a power receiving module of a wireless power data transmission device.

FIG. 7 is a plan view of the power transmitting module shown in FIG. 6 as viewed along an axis A.

FIG. 8 is a perspective view showing a configuration example of a magnetic core.

FIG. 9 is a cross-sectional view showing a configuration of a wireless power data transmission device according to an embodiment.

FIG. 10 is a plan view of the power transmitting module shown in FIG. 9 as viewed along the axis A.

FIG. 11 is a diagram showing, on an enlarged scale, a portion of the wireless power data transmission device shown in FIG. 9.

FIG. 12 is a graph showing an analysis result of the embodiment.

FIG. 13 is a diagram showing a variation of the embodiment.

FIG. 14 is a diagram showing another variation of the embodiment.

FIG. 15 is a diagram showing another example of a wireless power data transmission device.

FIG. 16 is a diagram showing another example of a wireless power data transmission device.

FIG. 17 is a block diagram showing a configuration of a system including a wireless power data transmission device.

FIG. 18A is a diagram showing an example of an equivalent circuit of a power transmitting coil and a power receiving coil.

FIG. 18B is a diagram showing another example of an equivalent circuit of a power transmitting coil and a power receiving coil.

FIG. 19A shows a configuration example of a full-bridge inverter circuit.

FIG. 19B shows a configuration example of a half-bridge inverter circuit.

FIG. 20 is a block diagram showing a configuration of a wireless power transmission system including two wireless power feeding units.

FIG. 21A is a diagram showing a wireless power transmission system including one wireless power feeding unit.

FIG. 21B is a diagram showing a wireless power transmission system including two wireless power feeding units.

FIG. 21C shows a wireless power transmission system including three or more wireless power feeding units.

### DESCRIPTION OF EMBODIMENTS

(Findings Forming Basis for Present Disclosure)

Findings forming the basis for the present disclosure will be described before describing embodiments of the present disclosure.

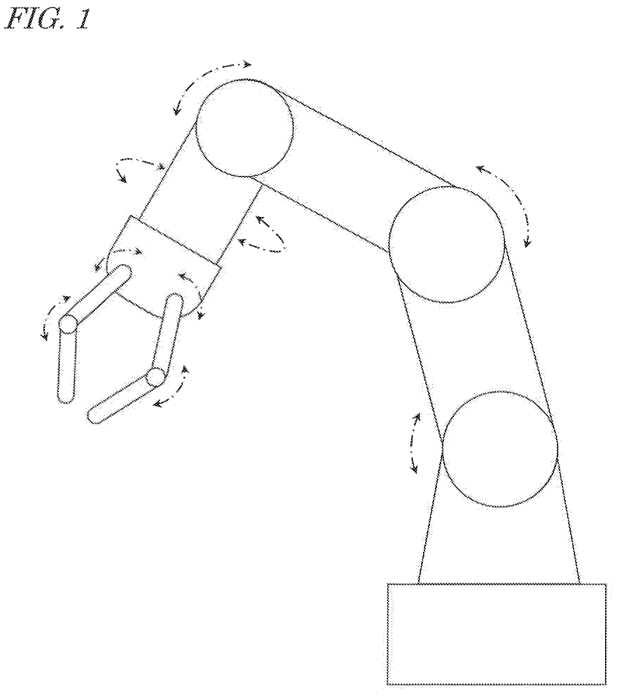

FIG. 1 is a diagram schematically showing an example of a robot arm device having a plurality of moving parts (e.g., joints). The moving parts are configured so that they can each be rotated or expanded/contracted by an actuator including an electric motor (hereinafter referred to simply as a “motor”). In order to such a device, it is required to control the motors by individually supplying electric power thereto. Power supply from the power source to a plurality of motors has been realized by connection via many cables.

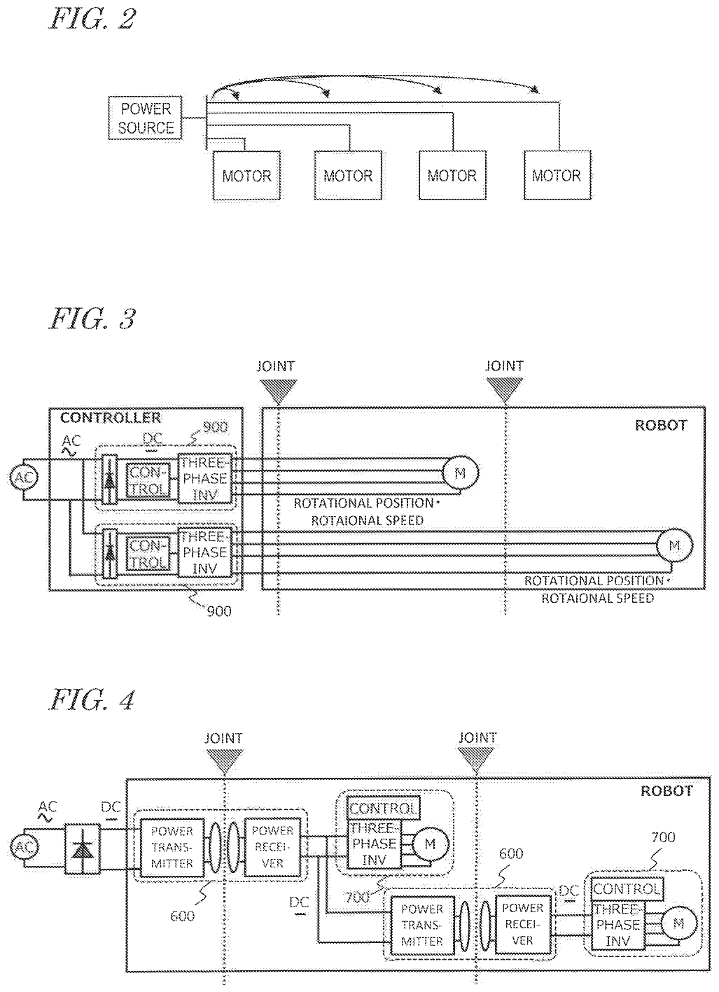

FIG. 2 is a diagram schematically showing the connection between components in such a conventional robot arm device. With the configuration shown in FIG. 2, electric power is supplied from the power source to a plurality of motors through wired bus connections. Each motor is controlled by a control device (or a controller).

FIG. 3 is a diagram showing a specific example of the conventional configuration shown in FIG. 2. The robot in this example has two joints. Each joint is driven by a servomotor M. Each servomotor M is driven by 3-phase AC power. The controller includes a number of motor driving circuits 900 in accordance with the number of motors M to be controlled. Each motor driving circuit 900 includes a converter, a 3-phase inverter and a control circuit. The converter converts alternating-current (AC) power from the power source to direct-current (DC) power. The 3-phase inverter converts DC power output from the converter to 3-phase AC power, and supplies the converted power to the motor M. The control circuit controls the 3-phase inverter so that necessary electric power is supplied to the motor M. The motor driving circuit 900 obtains information regarding the rotational position and the rotational speed from the motor M, and adjusts the voltage of each phase based on the information. With such a configuration, the action of each joint is controlled.

With such a configuration, however, there is a need to install many cables of a scale in accordance with the number of motors. Therefore, there are problems such as a high likelihood of accidents due to cables getting caught, the movable range being limited, and the replacement of parts being difficult. There are also problems such as the deterioration or breakage of cables from repeated bending. There is also a demand for installing the cables inside the arm in order to improve safety and vibration control. However, this requires many cables to be accommodated in joints, which poses a restriction to the automation of the manufacturing process. In view of this, the present inventors studied the application of a wireless power transmission technique to reduce the number of cables in moving parts of a robot arm.

FIG. 4 is a diagram showing a configuration example of a robot that wirelessly transfers electric power between joints. In this example, as opposed to the example of FIG. 3, the 3-phase inverter and the control circuit for driving the motor M are provided inside the robot rather than in an external controller. In each joint, wireless power transmission is performed via magnetic field coupling between a power transmitting coil and a power receiving coil. The robot includes, for each joint, a wireless power feeding unit and a small-sized motor. Small-sized motors 700A and 700B each include a motor M, a 3-phase inverter and a control circuit. Wireless power feeding units 600A and 600B each include a power transmitting circuit, a power transmitting coil, a power receiving coil and a power receiving circuit. The power transmitting circuit includes an inverter circuit. The power receiving circuit includes a rectifier circuit. The power transmitting circuit in the wireless power feeding unit 600A on the left side of FIG. 4 is connected between the power source and the power transmitting coil to convert the supplied DC power to AC power and supply the converted power to the power transmitting coil. The power receiving circuit converts the AC power, which the power receiving coil has received from the power transmitting coil, to DC power, and outputs the converted power. The DC power output from the power receiving circuit is supplied not only to the small-sized motor 700A, but also to the power transmitting circuit in the wireless power feeding unit 600B provided in another joint. Thus, electric power is supplied also to the small-sized motor 700B that drives another joint.

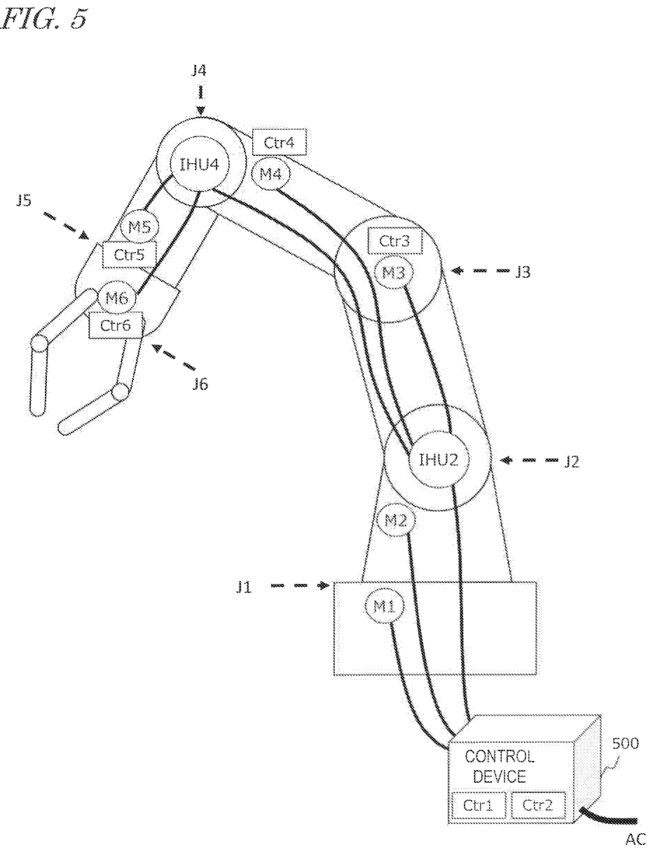

FIG. 5 is a diagram showing an example of a robot arm device to which the wireless power transmission described above is applied. This robot arm device includes joints J1 to J6. Of these joints, the wireless power transmission described above is applied to the joints J2 and J4. On the other hand, conventional wired power transmission is applied to the joints J1, J3, J5 and J6. The robot arm device includes a plurality of motors M1 to M6 for driving the joints J1 to J6, respectively, motor control circuits Ctr3 to Ctr6 for controlling the motors M3 to M6, respectively, of the motors M1 to M6, and two wireless power feeding units (referred to also as intelligent robot harness units: IHUs) INU2 and IHU4 provided at the joints J2 and J4, respectively. Motor control circuits Ctr1 and Ctr2 for driving the motors M1 and M2, respectively, are provided in a control device 500 outside the robot.

The control device 500 supplies electric power, by wire, to the motors M1 and M2 and the wireless power feeding unit IHU2. The wireless power feeding unit IHU2 wirelessly transfers electric power in the joint J2 via a pair of coils. The transferred electric power is supplied to the motors M3 and M4, the control circuits Ctr3 and Ctr4 and the wireless power feeding unit IHU4. The wireless power feeding unit IHU4 also wirelessly transfers electric power in the joint J4 via a pair of coils. The transferred electric power is supplied to the motors M5 and M6 and the control circuits Ctr5 and Ctr6. With such a configuration, it is possible to eliminate cables for power transmission in the joints J2 and J4.

In such a system, not only electric power but also data may be transferred in each wireless power feeding unit. For example, a signal for controlling each motor or a signal that is fed back from each motor may be transferred between the power transmitting module and the power receiving module in the wireless power feeding unit. Alternatively, where a camera is installed at the tip portion of the robot arm, data of an image captured by the camera may be transferred. Also, where a sensor is installed on the tip portion of the robot arm, a collection of data indicating the information obtained by the sensor may be transferred.

Such a wireless power feeding unit that transfers electric power and data simultaneously will be herein referred to as a “wireless power data transmission device”. A wireless power data transmission device is required to achieve both power transmission and data transmission with high quality.

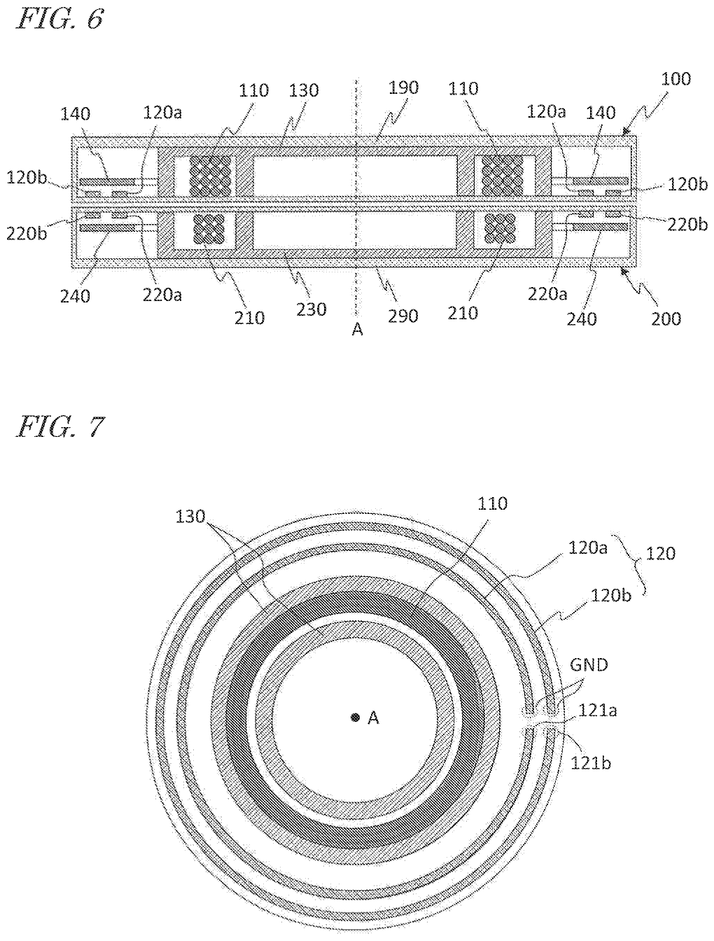

FIG. 6 is a cross-sectional view showing a configuration example of a wireless block portion of a power transmitting module 100 and a power receiving module 200 in a wireless power data transmission device. FIG. 7 is a plan view of the power transmitting module 100 shown in FIG. 6 as viewed along the axis A. While FIG. 7 illustrates a structure of the power transmitting module 100, the power receiving module 200 has a similar structure. At least one of the power transmitting module 100 and the power receiving module 200 can relatively rotate on the axis A by means of an actuator (not shown). The actuator may be provided in either one of the power transmitting module 100 and the power receiving module 200, or may be provided outside thereof.

The power transmitting module 100 includes a power transmitting coil 110, a communication electrode 120, a magnetic core 130, a communication circuit board 140 having a communication circuit, and a housing 190 accommodating these components. The communication electrode 120 includes a first electrode 120a, and a second electrode 120b that is farther away from the axis A than the first electrode 120a. Hereinafter, the two electrodes 120a and 120b may be referred to collectively as the “communication electrode 120”.

As shown in FIG. 7, the power transmitting coil 110 has a circular shape that is centered on the axis A. The two electrodes 120a and 120b have an arc shape (or a circular shape having slits) centered on the axis A. The two electrodes 120a and 120b are adjacent to each other with an interval therebetween. The communication electrode 120 and the power transmitting coil 110 are located on the same plane. The communication electrode 120 is located on the outer side of the power transmitting coil 110 so as to surround the power transmitting coil 110. The power transmitting coil 110 is accommodated in the magnetic core 130.

With the configuration shown in FIGS. 6 and 7, relative to the axis A, the power transmitting coil 210 and the power receiving coil 220 are arranged on the radially inner side, and the communication electrodes 120 and 220 are arranged on the radially outer side. The present disclosure is not limited to such a configuration, and the arrangement of the pair of the power transmitting coil 210 and the power receiving coil 210 and the communication electrodes 120 and 220 may be reversed. That is, advantageous effects to be described later can be achieved also with a configuration where the communication electrodes 120 and 220 are arranged on the radially inner side and the power transmitting coil 120 and the power receiving coil 220 are arranged on the radially outer side.

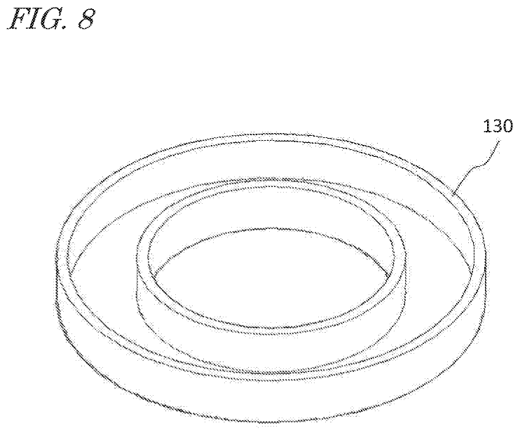

FIG. 8 is a perspective view showing a configuration example of the magnetic core 130. The magnetic core 130 shown in FIG. 8 includes an inner circumferential wall and an outer circumferential wall, which are concentric with each other, and a bottom surface portion that connects therebetween. The magnetic core 130 does not always need to have a structure in which the bottom surface portion is connected to the inner circumferential wall and the outer circumferential wall. The magnetic core 130 is made of a magnetic material. The wound power transmitting coil 110 is arranged between the inner circumferential wall and the outer circumferential wall of the magnetic core 130. As shown in FIG. 7, the magnetic core 130 is arranged so that the center thereof coincides with the axis A. The outer circumferential wall of the magnetic core 130 is located between the power transmitting coil 110 and the electrode 120a. As shown in FIG. 6, the magnetic core 130 is arranged so that the open portion that is opposite from the bottom surface is oriented so as to oppose the power receiving module 200.

The input/output terminal of the communication circuit is connected to one end 121a of the electrode 120a and one end 121b of the electrode 120b shown in FIG. 7. When transmitting signals, the communication circuit supplies two signals of opposite phases and the same amplitude to one end 121a of the electrode 120a and one end 121b of the electrode 120b, respectively. When receiving signals, it receives two signals sent from one end 121a of the electrode 120a and one end 121b of the electrode 120b. The communication circuit can demodulate the transferred signal by calculating the difference between the two signals. The other end of the electrodes 120a and 120b is connected to the ground (GND).

Thus, the two electrodes 120a and 120b function as a differential transmission line. Data transmission by the differential transmission line is not easily influenced by an electromagnetic noise. Using a differential transmission line enables data transmission at a higher speed. The communication circuit board 140 can be arranged at a position opposing the two electrodes 120a and 120b. The communication circuit described above is provided on the communication circuit board 140. Note that the communication circuit board 140 may be arranged at a position that is different from the position opposing the communication electrode 120.

The power transmitting coil 110 is connected to a power transmitting circuit (not shown). The power transmitting circuit supplies AC power to the power transmitting coil 110. The power transmitting circuit may include, for example, an inverter circuit for converting DC power to AC power. The power transmitting circuit may include a matching circuit for impedance matching. The power transmitting circuit may also include a filter circuit for suppressing an electromagnetic noise. A circuit board with the power transmitting circuit installed thereon may be arranged at a position adjacent to the power transmitting module 100 on the side opposite to the side on which the power receiving module 200 is located, for example.

The housing 190 may be formed of a conductive material, except for a portion thereof that opposes the housing 290 of the power receiving module 200. The housing 190 may serve a function of suppressing leakage of an electromagnetic field to the outside of the power transmitting module 100.

The power receiving module 200 has a similar configuration to the power transmitting module 100. The power receiving module 200 includes the power receiving coil 210, the communication electrode 220 including two electrodes 220a and 220b that function as a differential transmission line, a magnetic core 230, the communication circuit board 240, and the housing 290 accommodating these components. The configuration of these components is similar to the configuration of the corresponding components of the power transmitting module 100. In the present specification, the two electrodes 220a and 220b may be referred to collectively as “the communication electrode 220”.

The power receiving coil 210, the two electrodes 220a and 220b and the magnetic core 230 have a structure similar to the structure described above with reference to FIG. 7 and FIG. 8. The communication circuit board 240 is connected to one end of the two electrodes 220a and 220b, and transmits or receives two signals of opposite phases and the same amplitude. The communication circuit board 240 may be arranged in the housing 290 as shown in FIG. 6.

The power receiving coil 210 is arranged so as to oppose the power transmitting coil 110. The communication electrodes 220a and 220b on the power receiving side are arranged so as to oppose the communication electrodes 120a and 120b, respectively, on the power transmitting side. The power transmitting coil 110 and the power receiving coil 210 transfer electric power through magnetic field coupling. The communication electrodes 120a and 120b and the communication electrodes 220a and 220b transfer data via coupling between electrodes. Data can be transferred from either one of the power transmitting module 100 and the power receiving module 200. The power transmitting module 100 and the power receiving module 200 may each include two pairs of electrodes that function as a differential transmission line. With such a configuration, full-duplex communication can be realized in which signal transfer from the power transmitting side to the power receiving side and signal transfer from the power receiving side to the power transmitting side can be done simultaneously.

With the configuration described above, electric power and data can be simultaneously transferred wirelessly between the power transmitting module 100 and the power receiving module 200. With the configuration described above, since a differential transmission line is used, it is possible to suppress the influence of an electromagnetic noise from the power transmission section, as compared with an embodiment in which single-end transfer is used. Therefore, it is possible to improve the communication quality of the data transmission function section.

However, according to a study by the present inventors, when the amount of electric power to be transferred is large, there is a problem in that the communication quality of the data transmission section lowers due to the influence of a strong magnetic field generated around the coil when transferring electric power. When a part of the magnetic flux generated from the power transmitting coil 110 enters the communication electrodes 120 and 220, an electromotive force is generated through electromagnetic induction in the communication electrodes 120 and 220. The electromotive force generates, as a noise, a voltage that is irrelevant to the signal transferred. This noise may lower the SN ratio of communication, detracting from the communication quality.

With such a system as described above using a differential transmission line, the degree of influence differs between the electrode closer to the coil and the electrode farther away from the coil. It has been found that this may make the differential voltage unbalanced and may affect the operation.

Based on the above examination, the present inventors have arrived at the configuration of an embodiment of the present disclosure to be described below.

A transmission module according to an embodiment of the present disclosure is used as a power transmitting module or a power receiving module in a wireless power data transmission device for wirelessly transferring electric power and data between the power transmitting module and the power receiving module. The transmission module includes a coil for transmitting or receiving electric power through magnetic field coupling, a communication electrode for transmitting or receiving signals through electric field coupling, a first conductive shield located between the coil and the communication electrode, and a second conductive shield located between the coil and the first conductive shield.

According to the embodiment above, there are arranged the first conductive shield located between the coil and the communication electrode and the second conductive shield located between the coil and the first conductive shield. Thus, it is possible to reduce the influence of a magnetic flux generated from the coil when transferring electric power on the signal voltage at the communication electrode, and it is possible to improve the communication quality.

The communication electrode and the coil may be arranged on the same plane. The communication electrode and the coil may be arranged on different planes. The coil and the communication electrode may be arranged so as to oppose with each other with the first and second conductive shields interposed therebetween.

The power transmitting module and the power receiving module may be configured to move relative to each other. For example, the power transmitting module and the power receiving module may be configured so as to be rotatable relative to each other. In this case, the coil and the communication electrode may each have a circular shape or an arc shape centered on the same axis. With such a configuration, even when the power transmitting module and the power receiving module are rotated relative to each other, it is possible to maintain a state where the coil and the communication electrode of the power transmitting module and the coil and the communication electrode of the power receiving module oppose each other.

In one aspect, the communication electrode is located on the outer side of the coil. In another aspect, the communication electrode is located on the inner side of the coil. A magnetic material such as the magnetic core described above may be arranged between the communication electrode and the coil.

The power transmitting module and the power receiving module may be configured to be movable relative to each other along a first direction. For example, one of the transmission modules may include a linear actuator. In this case, the coil and the communication electrode may each have a shape that extends in the first direction. For example, the coil and the communication electrode may each have a rectangular shape or an elliptical shape. The communication electrode does not need to be arranged on the outer side or the inner side of the coil, and may be arranged adjacent to the coil.

The communication electrode may include two electrodes that function as a differential transmission line. The two electrodes are connected to the communication circuit. The communication circuit supplies signals of opposite phases and the same amplitude to the two electrodes. Alternatively, the communication circuit receives and demodulates signals of opposite phases and the same amplitude sent from the two electrodes. With such a configuration, it is possible to suppress the influence of an electromagnetic noise as compared with a case where the communication electrode is a single electrode.

The transmission module may further include a magnetic core that is located around the coil. The magnetic core may be located between the coil and the second conductive shield, and there may be a gap between the magnetic core and the second conductive shield. With such a configuration, it is possible to improve the transfer efficiency of the wireless power transmission section. This is because it is possible, with the configuration described above, to suppress the lowering of the Q value of the power transmitting coil and the power receiving coil of the wireless power transmission section.

In one aspect, the electric resistivity of the second conductive shield is lower than the electric resistivity of the first conductive shield. In that case, it is possible to further suppress the lowering of the Q value of the power transmitting coil and the power receiving coil.

The transmission module may further include an actuator that moves the power transmitting module and the power receiving module relative to each other. The actuator may include at least one motor. The actuator may be provided outside of the transmission module.

The transmission module may further include a power transmitting circuit that supplies AC power to the coil. In this case, the transmission module functions as a power transmitting module. The power transmitting circuit may include an inverter circuit, for example. The inverter circuit may be connected to the power source and the coil. The inverter circuit converts the DC power output from the power source to AC power for transfer, and supplies the converted power to the coil.

The transmission module may further include a power receiving circuit that converts AC power received by the coil to another form of electric power to output the converted power. In this case, the transmission module functions as a power receiving module. The power receiving circuit may include a power conversion circuit such as a rectifier circuit, for example. The power conversion circuit is connected between the coil and the load. The power conversion circuit converts AC power received by the coil to DC power or AC power as requested by the load, and supplies the converted power to the load.

The transmission module may further include a communication circuit connected to the communication electrode. When the communication electrode includes two electrodes forming a differential transmission line, two terminals of the communication circuit are connected to the two electrodes. The communication circuit functions as at least one of a signal transmitting circuit and a signal receiving circuit. When transmitting signals, the communication circuit supplies signals of opposite phases to the two electrodes.

A wireless power data transmission device according to another aspect of the present disclosure wirelessly transfers electric power and data between a power transmitting module and a power receiving module. The wireless power data transmission device includes the power transmitting module and the power receiving module. At least one of the power transmitting module and the power receiving module may be a transmission module in any one of the aspects described above.

The power transmitting module and the power receiving module may both be a transmission module in any one of the aspects described above. In that case, for both of the power transmitting module and the power receiving module, it is possible to reduce the influence of power transmission on communication.

In the wireless power data transmission device, the power transmitting module and the power receiving module do not need to have the same structure. For example, only the power transmitting module may include two conductive shields, and the power receiving module may include one conductive shield. Even with such an asymmetric configuration, it is possible to improve the communication quality of data transmission as compared with a conventional configuration.

The wireless power data transmission device may be used as a wireless power feeding unit in a robot arm device as shown in FIG. 1, for example. The application is not limited to a robot arm device, but the wireless power data transmission device can be applied to any device that includes a rotation mechanism or a linear motion mechanism. Moreover, the wireless power data transmission device can also be applied to a form of a device that does not include a rotation and linear motion function, in which an objective is to make functional connections non-contact connections.

The term “load” in the present specification means any device that operates based on electric power. A “load” may include a device such as a motor, a camera (imaging device), a light source, a secondary battery and an electronic circuit (e.g., a power conversion circuit or a microcontroller), for example. A device that includes a load and a circuit for controlling the load may be referred to as a “load device”.

A more specific embodiment of the present disclosure will now be described. Note however that unnecessarily detailed descriptions may be omitted. For example, detailed descriptions on what are well known in the art or redundant descriptions on substantially the same configurations may be omitted. This is to prevent the following description from becoming unnecessarily redundant, to make it easier for a person of ordinary skill in the art to understand. Note that the present inventors provide the accompanying drawings and the following description in order for a person of ordinary skill in the art to sufficiently understand the present disclosure, and they are not intended to limit the subject matter set forth in the claims. In the following description, identical or similar components are denoted by the same reference signs.

### EMBODIMENTS

A wireless power transmission data transmission device according to an exemplary embodiment of the present disclosure will be described. The wireless power transmission data transmission device may be used as a component of an industrial robot used in a factory, a worksite, or the like, as shown in FIG. 1, for example. Although the wireless power data transmission device may be used also for other applications (e.g., a power supply to an electric vehicle such as an electric car, etc.), an example application to an industrial robot will be mainly described in the present specification.

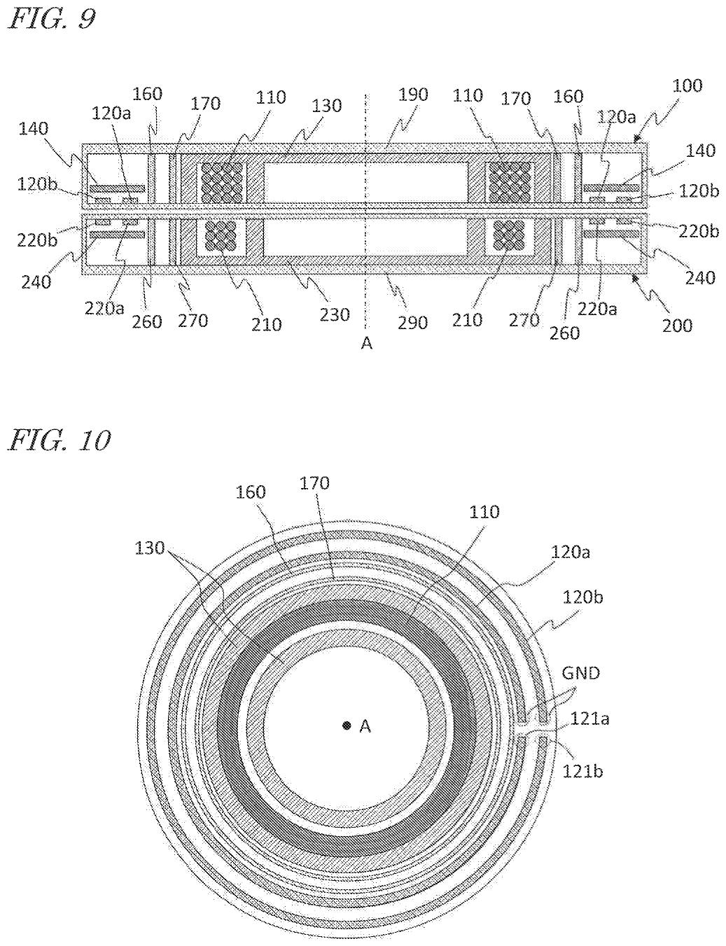

FIG. 9 is a cross-sectional view showing a configuration of the wireless power data transmission device according to the present embodiment. FIG. 10 is a plan view of the power transmitting module 100 shown in FIG. 9 as viewed along the axis A.

The wireless power data transmission device includes the power transmitting module 100 and the power receiving module 200. The power transmitting module 100 includes two conductive shields 160 and 170 between the two communication electrodes 120a and 120b and the magnetic core 130. Similarly, the power receiving module 200 includes two conductive shields 260 and 270 between the two communication electrodes 220a and 220b and the magnetic core 230. Other than these conductive shields 160, 170, 260 and 270, the configuration is similar to the configuration shown in FIG. 6.

As shown in FIG. 10, the conductive shields 160 and 170 have an annular shape centered on the axis A. Similarly, the conductive shields 260 and 270 of the power receiving module 200 have an annular shape centered on the axis A. The radius of the annular shape of the conductive shields 160 and 170 is larger than the radius of the outer circumferential wall of the magnetic core 130 and smaller than the radius of the inner electrode 120a. Similarly, the radius of the annular shape of the conductive shields 260 and 270 is larger than the radius of the outer circumferential wall of the magnetic core 230 and smaller than the radius of the inner electrode 220a. The conductive shields 160, 170, 260 and 270 may each have a shape with a slit, i.e., an arc shape, like the shape of the communication electrodes 120 and 220.

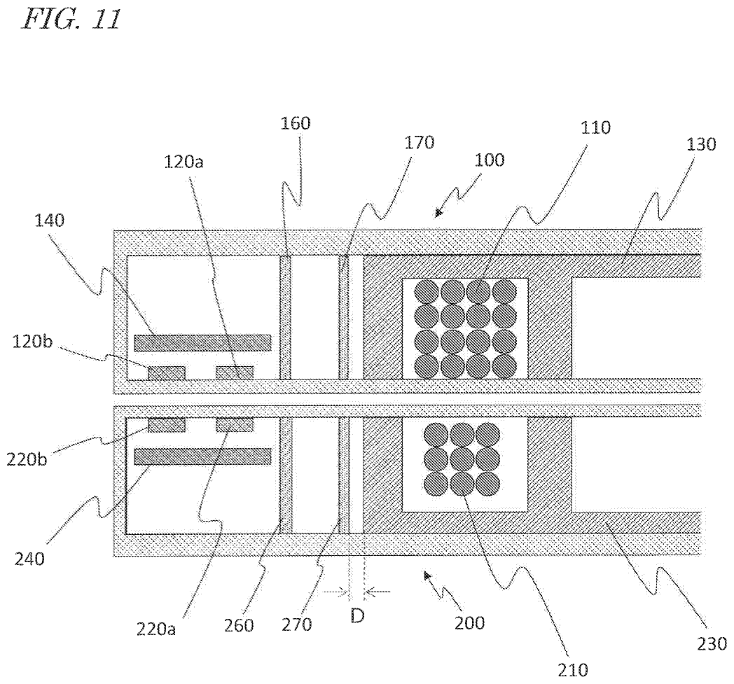

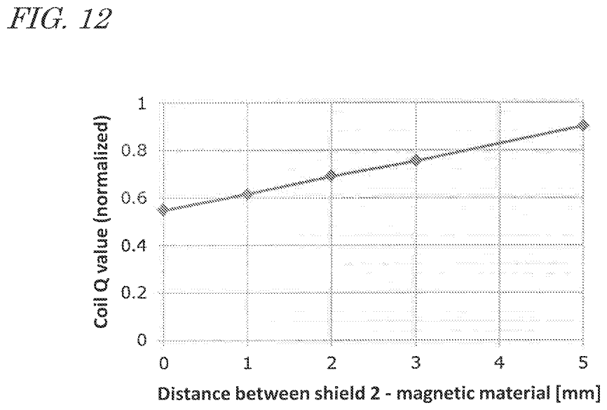

FIG. 11 is a diagram showing, on an enlarged scale, a portion of the wireless power data transmission device shown in FIG. 9. There is a gap between the inner electrode 120a, the conductive shield 160, the conductive shield 170 and the magnetic core 130 of the power transmitting module 100. Between the conductive shield 160 and the conductive shield 170 is a space that includes no magnetic material. Similarly, there is a gap between the inner electrode 220a, the conductive shield 260, the conductive shield 270 and the magnetic core 230 of the power receiving module 200. Between the conductive shield 260 and the conductive shield 270 is a space that includes no magnetic material.

Thus, two conductive members that are spaced apart from each other are arranged between the magnetic core 130 and the communication electrode 120 and between the magnetic core 230 and the communication electrode 220. It has been found that with such a configuration, as compared with a configuration in which only one conductive member is arranged, it is possible to significantly reduce the noise included in signals transmitted/received while transferring electric power.

The present inventors performed an electromagnetic field analysis for the present embodiment and for configurations of some comparative examples to examine the advantageous effects of the present embodiment. Table 1 shows the analysis results.

TABLE 1

| | | | | Two conductive shields | |
|---|---|---|---|---|---|
| | | One conductive shield | | Shields 1 | Shields 1 |
| | No | Only shield | Only shield | (Al) & | (Al) & |
| | shield | 1 (Al) | 2 (Al) | 2 (Al) | 2 (Cu) |
| S31 [dB] | −58.2 | −73.9 | −76.2 | −90.0 | −90.4 |
| S41 [dB] | −83.3 | −91.4 | −98.8 | −93.5 | −93.5 |
| S51 [dB] | −58.5 | −74.5 | −78.1 | −96.9 | −95.7 |
| S61 [dB] | −85.0 | −96.7 | −106.8 | −94.0 | −94.0 |
| Coil Q | 1.0 | 0.90 | 0.64 | 0.63 | 0.75 |
| value | | | | | |
| (normal- | | | | | |
| ized) | | | | | |

In the present electromagnetic field analysis, the passing characteristic for the communication electrodes 120a, 120b, 220a and 220b when AC power is supplied to the power transmitting coil 110, and the Q value of the power transmitting coil 110 and the power receiving coil 210 were calculated by electromagnetic field analysis. Similar values to sizes of various members of the actual configuration were used, and actual measured values were used for various parameters such as the electrical conductivity and the material loss. S31, S41, S51 and S61 in Table 1 each denote the ratio (S parameter) of the passing power for the communication electrodes 120a, 120b, 220a and 220b relative to the input electric power to the power transmitting coil 110.

For the power transmitting module 100 and the power receiving module 200, S31, S41, S51 and S61 were calculated for a case where no conductive shield is arranged, a case where only one conductive shield is arranged, and a case where two conductive shields are arranged. Herein, for when only one conductive shield is arranged, two cases were examined, i.e., a case where only the outer conductive shield 160, 260 (referred to as “Shield 1”) is arranged and a case where only the inner conductive shield 170, 270 (referred to as “Shield 2”) is arranged. In these examples, aluminum (Al) was selected as the material of Shield 1 and Shield 2. For a case where two conductive shields are arranged, two cases were examined, i.e., a case where Shields 1 and 2 are made of aluminum and a case where Shield 1 on the outer side is made of aluminum and Shield 2 on the inner side is made of copper (Cu). The electrical conductivity of copper is higher than the electrical conductivity of aluminum.

The value of S31, S41, S51 and S61 being smaller means that the influence of a magnetic flux generated from the power transmitting coil 110 on the communication electrode is smaller. Since the communication electrodes 120 and 220 of the present embodiment are each a differential transmission line, it is preferred that the values of S31 and S41 are close to each other and the values of S51 and S61 are close to each other.

It can be seen that as shown in Table 1, in each module, it is possible to suppress the passing strength and improve the communication quality only by arranging one conductive shield. Particularly, as compared with the passing strength (S41 and S61) for the communication electrodes 120b and 220b farther away from the coils 110 and 210, the reduction effect is low for the passing strength (S31 and S51) for the communication electrodes 120a and 220a closer to the coils 110 and 210, and there is an imbalance of the noise-superimposed passing characteristic for the communication electrodes.

In each module, by arranging two conductive shields, it is possible to reduce the passing strength (S31 and S51) for the communication electrodes 120a and 220a closer to the coils 110 and 210. On the other hand, the passing strength (S41 and S61) for the communication electrodes 120b and 220b farther away from the coils 110 and 210 is substantially unchanged from when there is one conductive shield. As a result, the values of S31 and S41 become generally equal to each other and the values of S51 and S61 become generally equal to each other, and it is possible to suppress the imbalance of the noise-superimposed passing characteristic for the communication electrodes.

Thus, it was found that in each module, it is possible to reduce the noise caused by the power transmission section that is superimposed on communication signals by using a configuration in which two conductive shields are arranged between the communication electrode and the magnetic core.

From the comparison between a case where Shield 2 on the inner side is made of aluminum and a case where it is made of copper, it was found that it is possible to suppress the lowering of the Q value of a coil for power transmission by making Shield 2 using a material of a low electric resistivity. Shield 2 on the inner side is not limited to copper and may be made of a material having a lower resistivity than the electric resistivity of an aluminum alloy. With such a configuration, it is possible to realize both the noise suppressing effect and the effect of suppressing the lowering of the Q value.

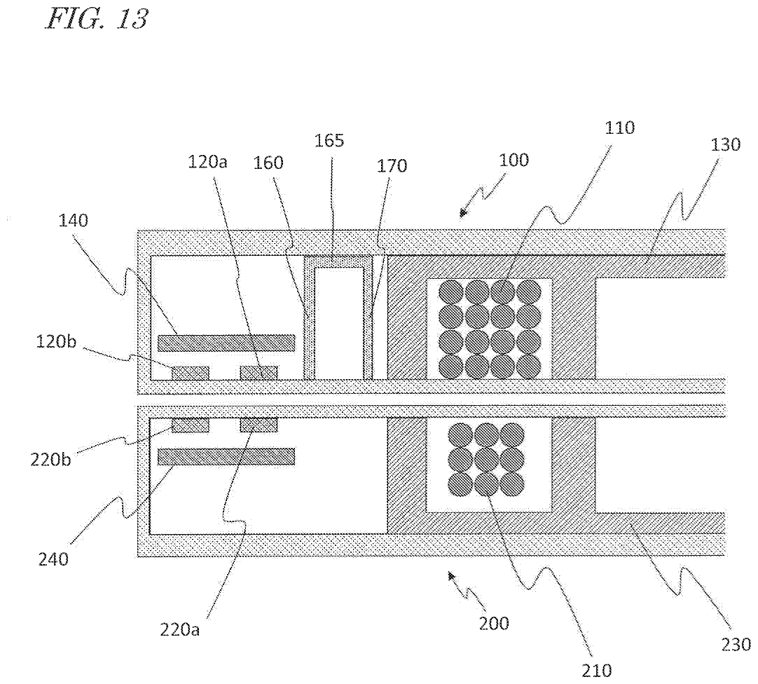

The present inventors further analyzed the change in the Q value when changing the distance D between the inner shields 170 and 270 (Shield 2) and the magnetic cores 130 and 230 (magnetic material) shown in FIG. 11 in the configuration where two conductive shields are arranged in each module. FIG. 12 is a graph showing the analysis result. It was confirmed that the lowering of the Q value of the coil is better suppressed by providing a gap between Shield 2 and the magnetic material and further increasing the distance D.

As described above, according to the present embodiment, two conductive shields 160 and 170 are arranged between the power transmitting coil 110 and the communication electrode 120, and two conductive shields 260 and 270 are arranged between the power receiving coil 210 and the communication electrode 220. The magnetic cores 130 and 230 are arranged around the coils 110 and 210, respectively. There is a gap between the magnetic core 130 and the conductive shield 170 and between the magnetic core 230 and the conductive shield 270. At least a portion of this gap may be filled with a dielectric having an arbitrary dielectric characteristic.

With such a configuration, it is possible not only to suppress the intensity of the noise superimposed by the power transmission section on the electrodes 120a and 120b and the electrodes 220a and 220b, each forming a differential transmission line, but also to suppress the imbalance of the intensity of the noise superimposed on the electrodes. Therefore, it is possible to improve the communication quality for data transmission under circumstances where electric power is being transferred in the vicinity thereof. The electric resistivity of the conductive shield 170 may be set to a value lower than the electric resistivity of the conductive shield 160. Similarly, the electric resistivity of the conductive shield 270 may be set to a value lower than the electric resistivity of the conductive shield 260. With such a configuration, it is possible to improve the power transmission efficiency between the coils 110 and 210.

In order to realize the advantageous effects described above, the number of conductive shields for each of the power transmitting module 100 and the power receiving module 200 is not limited to two, but it may be three or more. The advantageous effects described above can be realized as long as two or more conductive shields are provided in each module.

In the embodiment described above, the power transmitting module 100 and the power receiving module 200 both have two conductive shields. The improving effect can be realized also when only one of the power transmitting module 100 and the power receiving module 200 has two conductive shields.

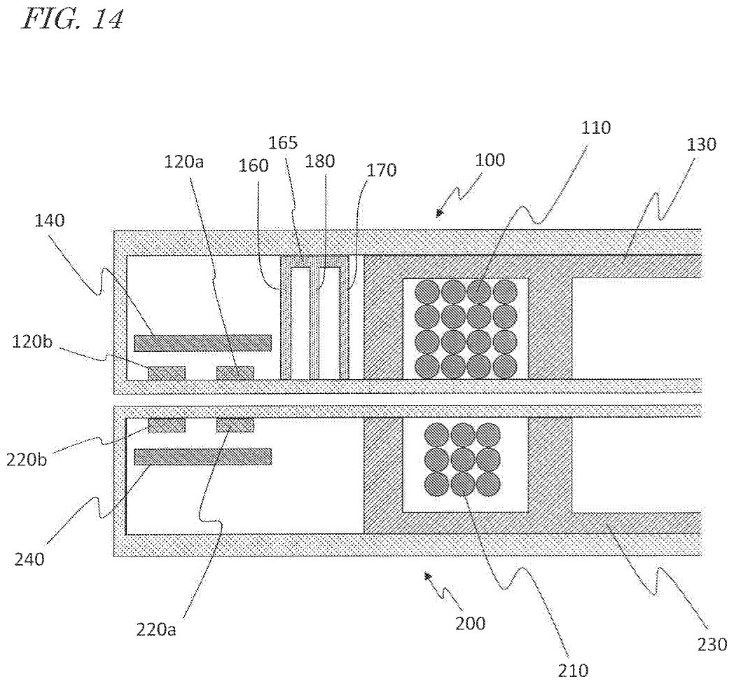

Regarding two conductive shields, it is sufficient that two or more conductive members are arranged with a gap in the space between the power transmitting coil 110 or the power receiving coil 210 and the communication electrode 120 or 220. These conductive members do not always need to be in a plate shape, but may have any shape. These conductive members do not need to be separated from each other. For example, as shown in FIG. 13, the conductive shields 160 and 170 may be connected together by a conductive connecting portion 165. In the example of FIG. 13, the cross section of the first conductive shield 160, the second conductive shield 170 and the connecting portion 165 taken along a plane that includes the axis of the power transmitting coil 110 has a U-shape. Herein, “U-shape” means to include two linear portions that are generally parallel to each other, and another linear portion that connects together end portions of the two linear portions. Alternatively, three conductive shields 160, 170 and 180 may be connected together by the connecting portion 165, as shown in FIG. 14. In the example of FIG. 14, the cross section of the conductive shields 160, 170 and 180 and the connecting portion 165 taken along a plane that includes the axis of the power transmitting coil 110 has an E-letter shape.

In the example of FIG. 13 and FIG. 14, only the power transmitting module 100 includes a plurality of conductive shields, and the power receiving module 200 does includes no conductive shield. The power receiving module 200 may include a conductive shield as shown in FIG. 13 or FIG. 14.

Each conductive shield may be formed of a metal such as copper or aluminum, for example. In addition, the following configurations may be used as a conductive shield or as an alternative thereof.
a configuration where a conductive paint (silver paint, copper paint, etc.) is applied on a side wall formed of an electric insulator
a configuration where a conductive tape (a copper tape, aluminum tape, etc.) is attached to a side wall formed of an electric insulator
a conductive plastic (a material obtained by kneading a plastic with a metal filler)

Any of these can realize functions equivalent to those of a conductive shield described above. These configurations will be referred to collectively as “conductive shield”.

Each conductive shield of the present embodiment has a ring-shaped structure along the power transmitting coil or the power receiving coil and the communication electrode. Each conductive shield may have a structure with a gap like a C-letter shape (i.e., an arc shape), as does each communication electrode. Also in that case, it is possible to reduce energy loss due to the generation of eddy current. The shield may have a polygonal or elliptical shape, for example. The shield may be formed by joining a plurality of metal plates. Moreover, each conductive shield may have one or more holes or slits. With such a configuration, it is possible to reduce energy loss due to the generation of eddy current.

In the present embodiment, the power transmitting coil or the power receiving coil and the communication electrode have an annular structure, and they are both rotatable relative to each other with the same axis as the rotation axis. The communication electrodes are arranged on the outer side of the power transmitting coil and the power receiving coil in the radial direction of a circle that is centered on the rotation axis. The structure is not limited to such a structure, and the communication electrodes may be arranged on the inner side of the power transmitting coil and the power receiving coil, for example. If a shielding member is arranged between the coil and the communication electrode, it is possible to suppress mutual interference.

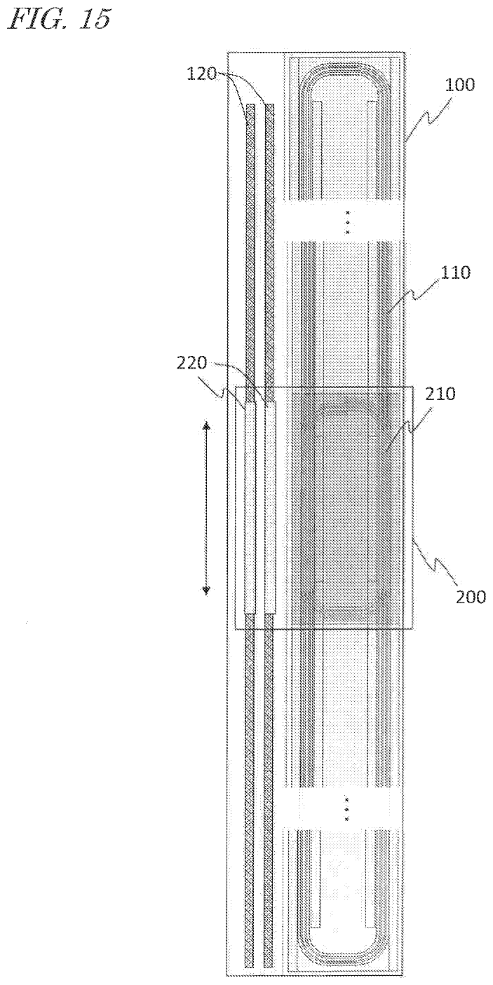

Moreover, each coil and each communication electrode may be shaped without the precondition that they rotate. For example, as shown in FIG. 15, each coil and each communication electrode may have a rectangular or oblong circular (elliptical) structure extending in the first direction (the longitudinal direction in FIG. 15). In that case, the power transmitting coil 110 and the communication electrode 120 and the power receiving coil 210 and the communication electrode 220 may be configured so that they can move relative to each other in the first direction by means of an actuator. With the configuration shown in FIG. 15, the power receiving coil 210 and the communication electrode 220 of the power receiving module 200 are smaller than the power transmitting coil 110 and the communication electrode 120 of the power transmitting module 100. Even if the power receiving module 200 moves relative to the power transmitting module 100, the state in which they oppose each other is maintained. Thus, electric power and data can be transferred while moving.

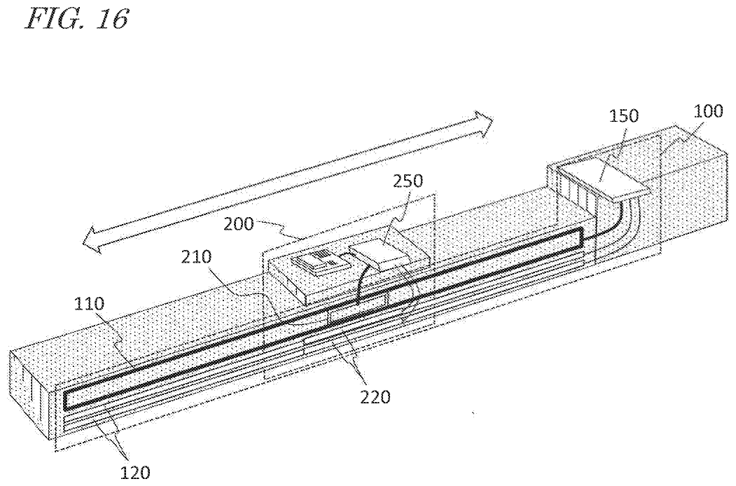

FIG. 16 is a diagram showing another example of a wireless power data transmission device. In this example, the power transmitting module 100 includes the control device 150, and the power receiving module 200 includes the control device 250. The control device 150 supplies AC power for power transmission to the power transmitting coil 110, and supplies AC power for signal transfer to the communication electrode 120. The control device 250 of the power receiving module 200 converts AC power received by the power receiving coil 210 from the power transmitting coil 210 to another form of electric power to supply the converted power to a load device such as a motor, and demodulates signals sent from the communication electrode 220. The communication electrode 120 is arranged adjacent to the power transmitting coil 110, and the communication electrode 220 is arranged adjacent to the power receiving coil 210. The power receiving module 200 translates relative to the power transmitting module 100 by means of a linear motion mechanism such as a linear actuator.

In the embodiments described above, each of the communication electrodes 120 and 220 includes two electrodes that function as a differential transmission line. Each of the communication electrodes 120 and 220 may include only one electrode. Even in that case, it is possible to realize the noise reduction effect from the provision of the two conductive shields described above.

Next, the configuration of a system including the wireless power data transmission device of the present embodiment will be described in greater detail.

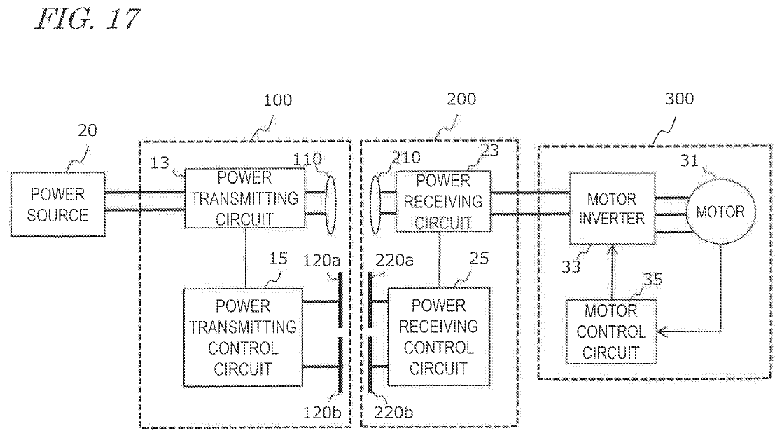

FIG. 17 is a block diagram showing a configuration of a system including a wireless power data transmission device. The present system includes the power source 20, the power transmitting module 100, the power receiving module 200 and a load 300. The load 300 in this example includes a motor 31, a motor inverter 33 and the motor control circuit 35. The load 300 is not limited to a device including the motor 31, but may be any device that operates based on electric power such as a battery, a lighting device and an image sensor, for example. The load 300 may be a power storage device for storing electric power such as a secondary battery or a power storage capacitor. The load 300 may include an actuator including the motor 31 that moves (e.g., rotates or linearly moves) the power transmitting module 100 and the power receiving module 200 relative to each other.

The power transmitting module 100 includes the power transmitting coil 110, the communication electrode 120 (the electrodes 120a and 120b), the power transmitting circuit 13 and the power transmitting control circuit 15. The power transmitting circuit 13 is connected between the power source 20 and the power transmitting coil 110, and converts DC power output from the power source 20 to AC power to output the converted power. The power transmitting coil 110 sends out the AC power output from the power transmitting circuit 13 into the space. The power transmitting control circuit 15 may be an integrated circuit including a microcontroller unit (MCU, hereinafter referred to also as a “microcomputer”) and a gate driver circuit, for example. The power transmitting control circuit 15 controls the frequency and the voltage of the AC power output from the power transmitting circuit 13 by switching between the conductive and non-conductive states of a plurality of switching elements included in the power transmitting circuit 13. The power transmitting control circuit 15 is connected to the electrodes 120a and 120b, and also transmits/receives signals via the electrodes 120a and 120b.

The power receiving module 200 includes the power receiving coil 210, the communication electrode 220 (the electrodes 220a and 220b), the power receiving circuit 23 and a power receiving control circuit 125. The power receiving coil 210 electromagnetically couples to the power transmitting coil 110 to receive at least a portion of the power transmitted from the power transmitting coil 110. The power receiving circuit 23 includes a rectifier circuit that convers the AC power output from the power receiving coil 210 to DC power, for example, and outputs the converted power. The power receiving control circuit 25 is connected to the electrodes 220a and 220b, and also transmits/receives signals via the electrodes 220a and 220b.

The load 300 includes the motor 31, the motor inverter 33 and the motor control circuit 35. The motor 31 in this example is a servo motor that is driven by three-phase alternating current, but may be a motor of another type. The motor inverter 33 is a circuit for driving the motor 31 and includes a three-phase inverter circuit. The motor control circuit 35 is a circuit such as an MCU for controlling the motor inverter 33. The motor control circuit 35 causes the motor inverter 33 to output desired three-phase AC power by switching between conductive and non-conductive states of a plurality of switching elements included in the motor inverter 33.

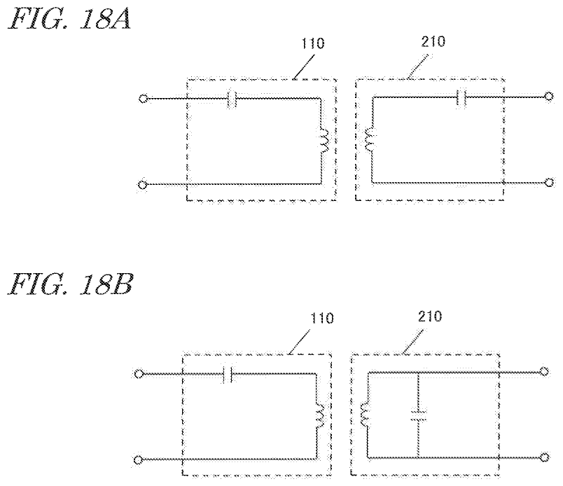

FIG. 18A is a diagram showing an example of an equivalent circuit of the power transmitting coil 110 and the power receiving coil 210. As shown in the figure, each coil functions as a resonance circuit having an inductance component and a capacitance component. It is possible to transfer electric power with a high efficiency by setting the resonance frequencies of two coils opposing each other to values close to each other. AC power is supplied to the power transmitting coil 110 from the power transmitting circuit 13. Electric power is transferred to the power receiving coil 210 by the magnetic field generated from the power transmitting coil 110 by this AC power. In this example, the power transmitting coil 110 and the power receiving coil 210 both function as a series resonance circuit.

FIG. 18B is a diagram showing another example of an equivalent circuit of the power transmitting coil 110 and the power receiving coil 210. In this example, the power transmitting coil 110 functions as a series resonance circuit, and the power receiving coil 210 functions as a parallel resonance circuit. In addition, an embodiment in which the power transmitting coil 110 forms a parallel resonance circuit is also possible.

Each coil may be, for example, a planar coil or a laminated coil formed on a circuit board, or may be a winding coil using a litz wire or a twisted wire formed of a material such as copper or aluminum. Each capacitance component in a resonance circuit may be realized by a parasitic capacitance of each coil, or a capacitor having a chip shape or a lead shape, for example, may be provided separately.

The resonance frequencies f0 of the resonance circuits are typically set so as to coincide with the transfer frequency f1 when transferring electric power. The resonance frequencies f0 of the resonance circuits do not need to strictly coincide with the transfer frequency f1. The resonance frequency f0 may be set to a value within the range of about 50% to 150% of the transfer frequency f1, for example. The power transmission frequency f1 may be set to 50 Hz to 300 GHz, for example, to 20 kHz to 10 GHz in an example, to 20 kHz to 20 MHz in another example, and to 80 kHz to 14 MHz in yet another example.

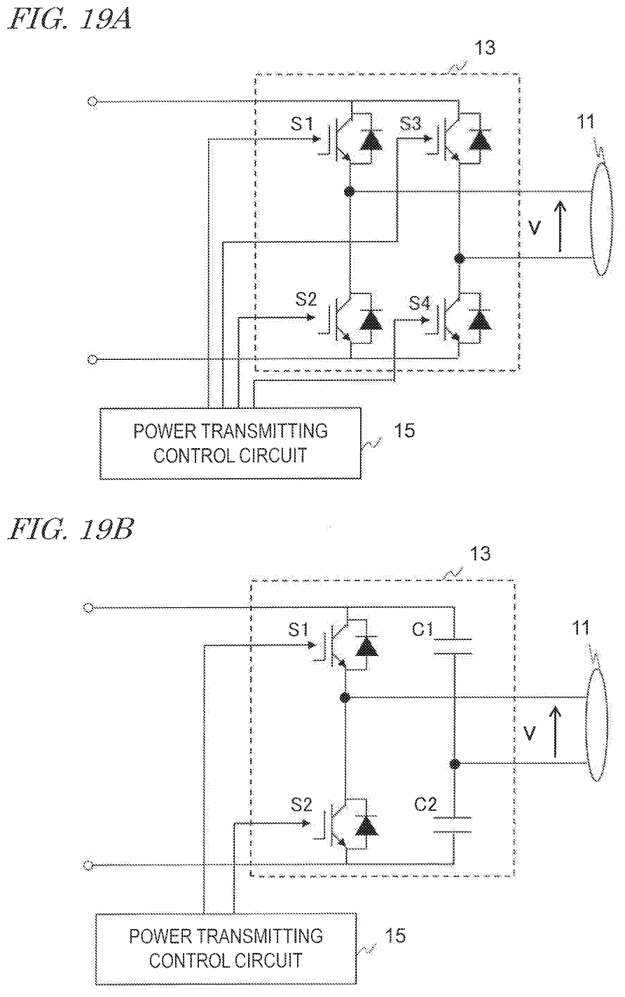

FIG. 19A and FIG. 19B are diagrams each showing a configuration example of the power transmitting circuit 13. FIG. 19A shows a configuration example of a full-bridge inverter circuit. In this example, the power transmitting control circuit 15 converts the input DC power to AC power that has desired frequency f1 and voltage V (effective value) by controlling ON/OFF of four switching elements S1 to S4 included in the power transmitting circuit 13. In order to realize this control, the power transmitting control circuit 15 may include a gate driver circuit that supplies control signals to the switching elements. FIG. 19B shows a configuration example of a half-bridge inverter circuit. In this example, the power transmitting control circuit 15 converts the input DC power to AC power having desired frequency f1 and voltage V (effective value) by controlling ON/OFF of two switching elements S1 and S2 included in the power transmitting circuit 13. The power transmitting circuit 13 may have a structure difference from the configuration shown in FIG. 19A and FIG. 19B.

The power transmitting control circuit 15, the power receiving control circuit 25 and the motor control circuit 35 may be realized by a circuit including a processor and a memory, such as a microcontroller unit (MCU), for example. Various controls can be performed by executing a computer program stored in the memory. The power transmitting control circuit 15, the power receiving control circuit 25 and the motor control circuit 35 may be implemented by dedicated hardware that is configured to perform the operation of the present embodiment. The power transmitting control circuit 15 and the power receiving control circuit 25 function also as communication circuits. The power transmitting control circuit 15 and the power receiving control circuit 25 can transfer signals or data to each other via the communication electrodes 120 and 220.

The motor 31 may be a motor that is driven by 3-phase alternating current, such as a permanent magnet synchronous motor or an induction motor, for example, but it is not limited thereto. The motor 31 may be a motor of another type such as a DC motor. In that case, a motor driving circuit in accordance with the structure of the motor 31 is used, instead of the motor inverter 33, which is a 3-phase inverter circuit.

The power source 20 may be any power source that outputs a DC power source. The power source 20 may be any power source such as a commercial power source, a primary battery, a secondary battery, a solar battery, a fuel battery, a USB (Universal Serial Bus) power source, a high-capacity capacitor (e.g., an electric double layer capacitor), a voltage converter connected to a commercial power source, for example.

### Other Embodiments

A wireless power transmission system according to another embodiment of the present disclosure includes a plurality of wireless power feeding units and a plurality of loads. The wireless power feeding units are connected in series, and each supply electric power to one or more loads connected thereto.

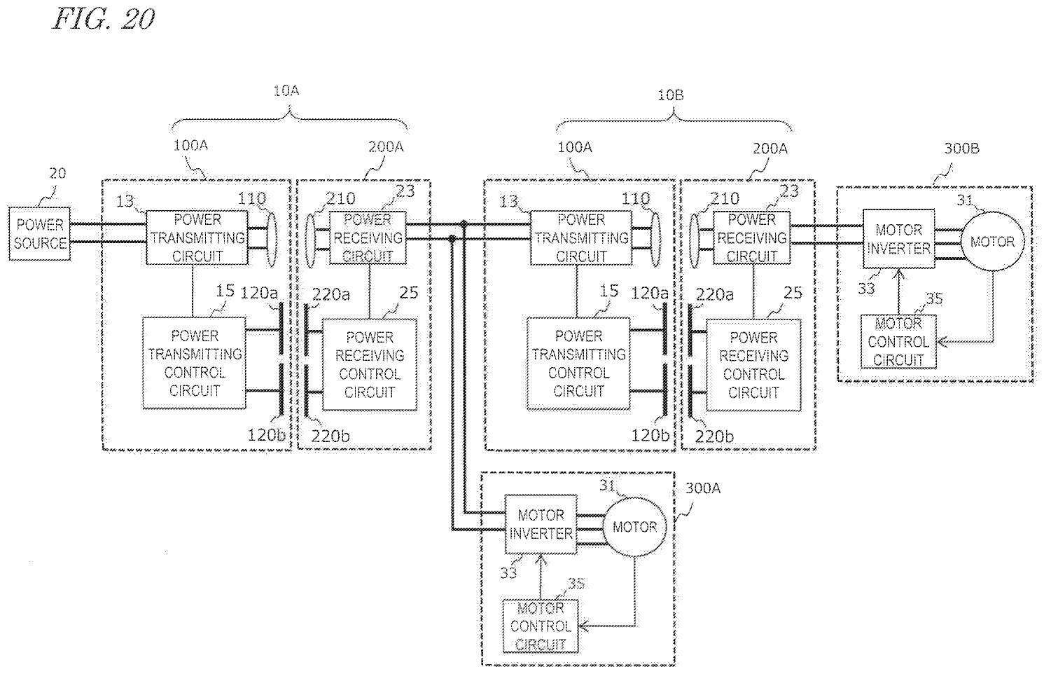

FIG. 20 is a block diagram showing a configuration of a wireless power transmission system including two wireless power feeding units. This wireless power transmission system includes two wireless power feeding units 10A and 10B and two loads 300A and 300B. The number of wireless power feeding units and the number of loads are not limited to two but may be three or more.

Each of the power transmitting modules 100A and 100B includes similar elements to the power transmitting module 100 of the embodiment described above. Each of the power receiving modules 200A and 200B includes similar elements to the power receiving module 200 of the embodiment described above. The loads 300A and 3003 receive electric power from the power receiving modules 200A and 2003, respectively.

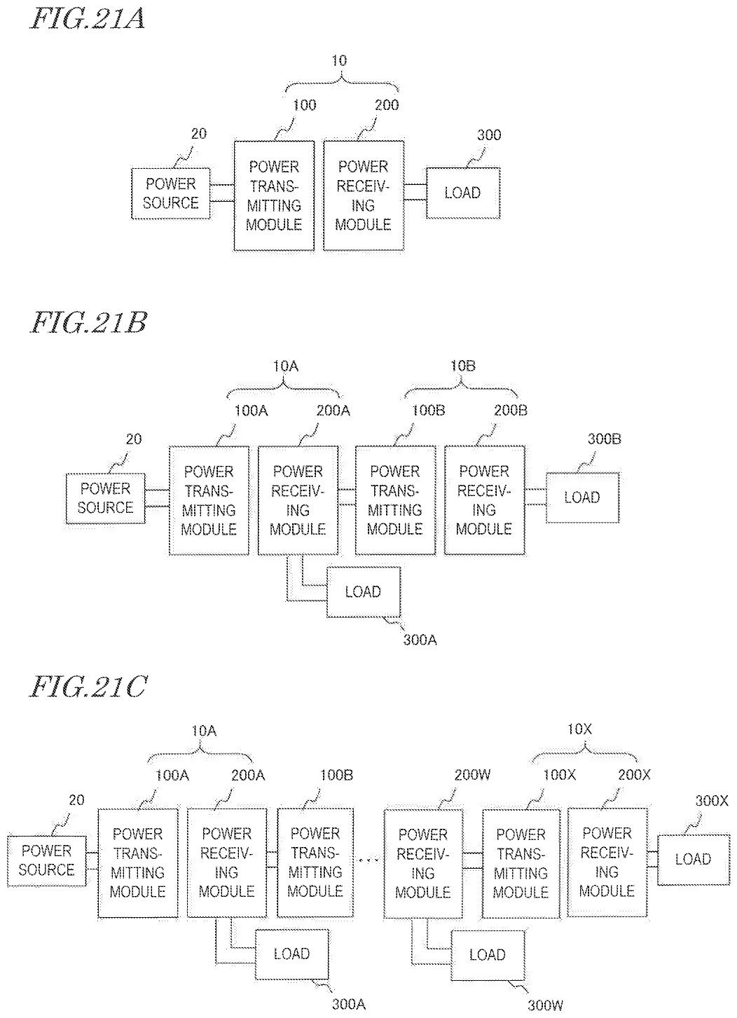

FIG. 21A to FIG. 21C are diagrams each schematically showing a configuration type of the wireless power transmission system of the present disclosure. FIG. 21A shows a wireless power transmission system including one wireless power feeding unit 10. FIG. 21B shows a wireless power transmission system including two wireless power feeding units 10A and 10B provided between the power source 20 and the load 3003 at the end. FIG. 21C shows a wireless power transmission system including three or more wireless power feeding units 10A to 10X provided between the power source 20 and a load device 300X at the end. The technique of the present disclosure is applicable to any of the embodiments of FIGS. 21A to 21C. With the configuration as shown in FIG. 21C, it is applicable to an electric-powered device such as a robot having many moving parts as described above with reference to FIG. 1, for example.

With the configuration of FIG. 21C, the configuration of the embodiment described above may be applied to all the wireless power feeding units 10A to 10X, or the configuration may be applied only to some of the wireless power feeding units.

### INDUSTRIAL APPLICABILITY

The technique of the present disclosure can be used in an electric-powered device such as a robot, a surveillance camera, an electric vehicle or a multi-copter used in a factory or a worksite, or the like, for example.

### REFERENCE SIGNS LIST

10 Wireless power feeding unit
13 Power transmitting circuit
15 Power transmitting control circuit
23 Power receiving circuit
31 Motor
33 Motor inverter
35 Motor control circuit
50 Power source
100 Power transmitting module
110 Power transmitting coil
120a, 120b First communication electrode
130 Magnetic core
140 Communication circuit board
160 First conductive shield
170 Second conductive shield
180 Third conductive shield
190 Housing
200 Power receiving module
210 Power receiving coil
220a, 220b Second communication electrode
230 Magnetic core
240 Communication circuit board
260 Third conductive shield
270 Fourth conductive shield
280 Fifth conductive shield
290 Housing
300 Load
500 Control device
600 Wireless power feeding unit
700 Small-sized motor
900 Motor driving circuit

1. A transmission module used as a power transmitting module or a power receiving module in a wireless power data transmission device for wirelessly transferring electric power and data between the power transmitting module and the power receiving module, the transmission module comprising:
a coil for transmitting or receiving electric power through magnetic field coupling;
a communication electrode for transmitting or receiving signals through electric field coupling;
a first conductive shield that is located between the coil and the communication electrode; and
a second conductive shield that is located between the coil and the first conductive shield.

2. The transmission module according to claim 1, wherein:
the transmission module further comprises a conductive connecting portion that connects together the first conductive shield and the second conductive shield; and
a cross section of the first conductive shield, the second conductive shield and the connecting portion taken along a plane that includes an axis of the coil has a U-shape.

3. The transmission module according to claim 1, wherein the communication electrode and the coil are located on the same plane.

4. The transmission module according to claim 1, wherein:
the power transmitting module and the power receiving module are rotatable relative to each other; and
the coil and the communication electrode each have a circular shape or an arc shape centered on the same axis.

5. The transmission module according to claim 4, wherein the communication electrode is located on an outer side of the coil.

6. The transmission module according to claim 1, wherein:
the power transmitting module and the power receiving module are movable relative to each other along a first direction; and
the coil and the communication electrode each have a shape that extends in the first direction.

7. The transmission module according to claim 6, wherein the coil and the communication electrode each have a rectangular shape or an elliptical shape.

8. The transmission module according to claim 1, wherein the communication electrode includes two electrodes that function as a differential transmission line.

9. The transmission module according to claim 8, wherein:
the power transmitting module and the power receiving module are rotatable relative to each other;
the coil and the communication electrode each have a circular shape or an arc shape centered on the same axis; and
the communication electrode includes a first electrode and a second electrode that is farther away from the axis than the first electrode.

10. The transmission module according to claim 1, wherein:
the transmission module further comprises a magnetic core that is located around the coil;
the magnetic core is located between the coil and the second conductive shield; and
there is a gap between the magnetic core and the second conductive shield.

11. The transmission module according to claim 10, wherein between the first conductive shield and the second conductive shield is a space that includes no magnetic material.

12. The transmission module according to claim 1, wherein an electric resistivity of the second conductive shield is lower than an electric resistivity of the first conductive shield.

13. The transmission module according to claim 1, further comprising an actuator that moves the power transmitting module and the power receiving module relative to each other.

14. The transmission module according to claim 1, wherein:
the transmission module is the power transmitting module; and
the transmission module further comprises a power transmitting circuit that supplies AC power to the coil.

15. The transmission module according to claim 1, wherein:
the transmission module is the power receiving module; and
the transmission module further comprises a power receiving circuit that converts AC power received by the coil to another form of electric power to output the converted power.

16. The transmission module according to claim 1, further comprising a communication circuit that is connected to the communication electrode.

17. The transmission module according to claim 1, wherein the coil and the communication electrode oppose each other with the first and second conductive shields interposed therebetween.

18. A wireless power data transmission device for wirelessly transferring electric power and data between a power transmitting module and a power receiving module, the wireless power data transmission device comprising:
the power transmitting module; and
the power receiving module,
wherein at least one of the power transmitting module and the power receiving module is the transmission module according to claim 1.
